(19) United States
(12) Patent Application Publication
(10) Pub. No.: US 2025/0025886 A1
(43) Pub. Date: Jan. 23, 2025

(54) CUTTING KNIFE FOR MIXING AUGERS OF A FEED MIXER

(71) Applicant: Trioliet B. V., Oldenzaal (NL)

(72) Inventor: Robert Jan LIET, Oldenzaal (NL)

(21) Appl. No.: 18/771,971

(22) Filed: Jul. 12, 2024

(30) Foreign Application Priority Data
Jul. 19, 2023 (DE) 202023104037.3

(51) Int. Cl. B02C 18/18; A23N 17/00; B01F 27/172; B01F 27/922; B01F 101/18; B02C 18/06; B02C 18/12

(52) U.S. Cl. CPC B02C 18/18; A23N 17/007; B01F 27/172; B01F 27/922; B02C 18/067; B02C 18/12; B01F 2101/18

(57) ABSTRACT

Feed mixer for shredding and mixing feed, in particular fibrous plant material, comprising a mixing container for receiving feed, wherein the mixing container has a base and a wall extending upwardly from the base, wherein the mixing container comprises a mixing auger arranged to be rotatable in the mixing container, wherein the mixing auger comprises at least one cutting knife, wherein the at least one cutting knife comprises a plurality of segments, wherein the plurality of segments each comprises a blade edge, and wherein the segments are spaced from one another by recesses.

### FIELD OF THE INVENTION

The invention relates to a feed mixer for shredding and mixing feed, in particular fibrous plant material.

### BACKGROUND OF THE INVENTION

Feed mixers are becoming increasingly popular in agriculture and comprise a mixing container in which at least one mixing tool is moved for mixing feed. The mixing container typically has a base and a substantially conically widening front wall and rear wall as well as mostly flattened side walls. Furthermore, the mixing container is often open on its side facing upward so that it can be loaded through this opening. The mixing tool is typically configured as a mixing auger that tapers towards the top and is driven about a vertical axis such that the feed that is filled in is conveyed upwardly and flows back to the base of the mixing container where it is fed back to the mixing tool. In this manner, the feed is mixed and loosened. A feed mixer of this type is known, for example, from EP 1 527 678 A1.

A further feed mixer is known, for example, from EP 1 417 999. This publication describes a mixing auger with cutting knives that protrude beyond the edge of the mixing auger. The cutting knives lie in a substantially horizontal plane and are each held by way of a radial holding structure by the axis of rotation of the mixing auger. During operation, feed can be shredded with the cutting knives.

U.S. Pat. No. 5,456,416 and EP 1 634 494 B1 describe further feed mixers in which a plurality of cutting knives is attached to an auger blade and protrude outwardly beyond the edge of the auger blade.

The service life of cutting knives, however, is sometimes unsatisfactory since the blade edges of the cutting knife, in particular in the case of profiled blade edges, such as corrugated or jagged blade edges, can wear out quickly during operation.

### SUMMARY OF THE INVENTION

The object of the invention is therefore to provide a feed mixer in which the cutting knives remain usable for longer time.

This object is satisfied by a feed mixer according to an embodiment of the invention. Further developments are to be found in the other embodiments of the invention.

The invention therefore provides a feed mixer for shredding and mixing feed, in particular fibrous plant material, comprising a mixing container for receiving feed, where the mixing container has a base and a wall extending upwardly from the base, where the mixing container comprises a mixing auger arranged to be rotatable in the mixing container, where the mixing auger comprises at least one cutting knife, where the at least one cutting knife comprises a plurality of segments, where the plurality of segments each comprises a blade edge, and where the segments are spaced from one another by recesses.

It has been shown that with such a feed mixer, the blade edge of the at least one cutting knife or the blade edges of the plurality of segments remain intact for a longer time. It has also been shown that less feed moves along the blade edge because the feed is slowed down by the recesses. As a result, the blade edges of the plurality of segments are worn less. It has also been shown that the at least one cutting knife of such a feed mixer is more flexible.

The cutting knife can comprise, in particular, two or more segments.

In the following, the width of a recess can be understood, in particular, to be the distance between adjacent segments separated by the recess. The depth of a recess can, in particular, be understood to be the extension of the recess perpendicular to the width of the recess.

The knife blade of the at least one cutting knife can be understood, in particular, to be a base body on which the plurality of segments is formed. The knife blade can also have one or more, in particular two, mounting holes in order to be able to mount the at least one cutting knife, for example, using screws, rivets or bolts, to the mixing auger, in particular, to the auger blade of the mixing auger.

The cutting knife can therefore be connected to the mixing auger, in particular, in a non-destructively detachable manner.

In the case of two mounting holes, a depression can be arranged between the mounting holes on the side of the cutting knife facing the auger blade during assembly. This depression can compensate at least in part for a deformation of the region, in which the mounting holes are arranged, in the course of the assembly of the cutting knife. Without such a depression, the mounting region of the cutting knife can deform when it is connected, in particular screwed, to the auger blade. Such deformations can in turn have a negative effect on the stability and therefore the service life of the cutting knife. The depression can also be part of an arched region between the mounting holes, where the curvature of the arched region in the mounted state points away from the auger blade.

More than one, for example, two, mixing augers can also be arranged in the mixing container. Each of the mixing augers can then comprise at least one cutting knife described herein. If features of a mixing auger are therefore described herein, the one or more further mixing augers can have corresponding features.

The axis of rotation of the mixing auger can be arranged vertically in the mixing container, i.e. run perpendicular to the base of the mixing container.

The mixing auger can also comprise more than one, for example, three or five, cutting knives. The cutting knives can there be formed to be different or the same. In particular, only some of the cutting knives can be formed according to the invention. For example, five cutting knives can be mounted on the mixing auger, where only the top two of the five cutting knives mounted are formed according to the invention. As a result, the cutting knife according to the invention can be employed in regions where high wear is expected, while simpler cutting knives are used in other regions where less wear is expected.

If there is more than one mixing auger, for example, two or three mixing augers, the cutting knives of the mixing augers can be formed to be the same or different. For example, at least one cutting knife of a mixing auger can be formed to be longer than the cutting knives of the other mixing augers and/or shaped such that the at least one cutting knife provides more resistance to the feed during the mixing process than the cutting knives of the other mixing augers. This can improve the discharge of feed, for example, via a discharge opening in the mixing container. For example, three mixing augers can be arranged in the direction of travel, one behind the other in a mixing container, where the at least one cutting knife of the mixing auger that is closest to a discharge opening is formed to be longer or to provide more resistance when mixing feed. The discharge opening can be closest in the direction of travel to the forward or center mixing auger. It is also conceivable that at least one cutting knife of the mixing auger that is rearmost in the direction of travel is longer or has more resistance when mixing feed. This can increase the conveyance of feed from the rearmost mixing auger to the forwardmost mixing auger and thereby improve the mixing process, for example, for feed mixers loaded in the region of the rearmost mixing auger, for example, in the case of respective self-loading feed mixers.

For example, with three mixing augers, at least one cutting knife of a center mixing auger can also be configured such that better circulation of feed takes place in the mixing container. This can improve the mixing of feed.

A recess can be, in particular, a groove, a notch, a cutout, an indentation or a depression. A recess can be understood to mean, in particular, a space that is left free during the manufacture of the component or is subsequently removed. The recesses can be cut out of the at least one cutting knife, for example, using a laser cutter, for example, a 3D laser cutting head, or can be removed from the at least one cutting knife using a milling machine. The recess can be formed, in particular, to be U-shaped.

The plurality of segments can be formed to be different. In particular, the plurality of segments can be formed to have different widths.

The blade edges of the plurality of segments can have a profile, i.e. in particular that the blade edges do not have to be straight or smooth. The blade edges of the plurality of segments can be formed, for example, to be corrugated, grooved, jagged, toothed and/or zigzag-shaped.

The blade edges of the plurality of segments and/or the plurality of segments can lie in a plane. This plane can be referred to as a cutting plane. In other words, the cutting knife can be configured such that the plurality of segments is not angled relative to one another. The cutting plane of the cutting knife can lie substantially perpendicular to the axis of rotation of the mixing auger.

In the case of profiled blade edges, the cutting plane of the cutting knife can correspond to the plane in which the blade edges lie equally above and below the plane. For example, in the case of a corrugated blade edge, as compared to a straight blade edge, the blade edge can lie in part above or in part below the cutting plane due to the corrugated shape.

The blade edges of the plurality of segments can point in the direction of rotation of the mixing auger. In particular, it is conceivable that the blade edges of the plurality of segments are arranged transversely, i.e. at a right angle, or at an angle other than 90° relative to the direction of rotation of the mixing auger and/or to the circular path about the axis of rotation of the mixing auger.

The upper side and/or underside of the knife blade of the at least one cutting knife can be flat. It is also conceivable that the knife blade of the at least one cutting knife has reinforcements on the upper side and/or underside. Reinforcements are to be understood, in particular, to be modifications with which the rigidity of a component can be increased by modifying the shape and/or material and/or with reinforcement elements, e.g. with struts, press-ins, and/or deformations.

It is also conceivable that the knife blade of the at least one cutting knife is shaped such that the at least one cutting knife can be mounted onto the mixing auger, in particular onto the auger blade of the mixing auger, in such a way that the cutting plane of the plurality of segments is substantially perpendicular to the axis of rotation of the mixing auger. This makes it possible for the at least one cutting knife to be moved horizontally in the feed mixer, i.e. parallel to the base of the mixing container. In particular, in comparison to a mounting in which the at least one cutting knife forms an outward extension of the mixing auger and therefore the cutting plane of the plurality of segments is at an angle to the horizontal, the at least one cutting knife with a horizontal cutting plane is less likely to push the feed upwardly into a region in which the feed normally drops down when the feed is mixed. This means that the mixing motion in the mixing container is less disrupted.

The recesses can be formed to be the same or different. The recesses can be formed to have different depths and/or widths. The recesses can be formed to be, for example, between 20-30 mm deep and 6-8 mm wide. The width and/or depth of the recesses can increase or decrease with increasing distance from the axis of rotation of the mixing auger. The width of the recesses can be shorter than the width of the adjacent segments, in particular shorter than half the width, in particular shorter than a quarter of the width of the adjacent segments. The depth of the recesses can be longer than the width of the adjacent segments, in particular longer than half the width, in particular longer than a quarter of the width of the adjacent segments. The recesses can be arranged to be parallel to one another. In other words, the recesses can extend in the depth direction along parallel lines that are offset from one another. It is also conceivable that the recesses extend in the depth direction along lines that are offset from one another and that intersect at an angle, in particular an acute angle, i.e. in other words, are not parallel to one another.

The recesses can therefore be arranged or run at different angles relative to one another and/or relative to the direction of rotation of the mixing auger.

It is also conceivable that the width of the recesses varies in the depth direction. In particular, the width at the deepest point of the recess can be smaller than at the highest point of the recess, for example, the recess can be V-shaped.

The recesses can be formed such that as much or as little feed as possible gets into the recesses when the mixing auger rotates. For example, the recesses can extend substantially in the direction of rotation of the mixing auger or along a circular path about the axis of rotation of the mixing auger or at an angle of −30° to +40° relative to the direction of rotation of the mixing auger or to a circular path about the axis of rotation of the mixing auger. This makes it as easy as possible for feed to get into the recesses and accumulate there when the mixing auger is in operation. In addition, this can extend the cutting length along which feed can be shredded, in particular, in embodiments in which each recess comprises at least one edge.

Alternatively, it is conceivable that the recesses extend substantially transverse or at an angle of 50° to 80° to the direction of rotation of the mixing auger or to a circular path about the axis of rotation of the mixing auger. This can make it more difficult for the feed to get into the recesses and accumulate when the mixing auger is in operation.

The angle at which the recess is arranged relative to the direction of rotation and/or to the circular path can, in particular, correspond to the angle which the recess encloses with respect to an arrangement along the direction of rotation or circular path.

A positive angle can there denote an angle starting out from the circular path in an anti-clockwise direction and a negative angle can denote an angle starting out from the circular path in a clockwise direction.

Each recess can comprise at least one edge. This allows the feed to fold over the edge and be broken or also cut. The at least one edge can then extend along the depth direction and/or along the width of the recess. The at least one edge can be burred, sharp-edged, or grooved. This allows the feed to be broken or cut as effectively as possible. “Burred” can mean, in particular, that the at least one edge has not been deburred. A burr can be, in particular, an edge, fraying, or splinter that has arisen during the machining or manufacturing process.

The blade edges of the plurality of segments can be hardened, in particular, hardened more than the remaining part of the at least one cutting knife. This can improve the strength of the blade edges of the plurality of segments. “Hardening” can be understood, in particular, to be a process in which the microstructure, also referred to as the structure, of a region is changed in order to increase its mechanical resistance. The hardened regions are typically stronger, but also more brittle and therefore more susceptible to fracture. Since the segments are spaced from one another by the recesses, in particular, also the hardened blade edges of the plurality of segments can be spaced from one another. This results in a synergistic effect in that the blade edges of the plurality of segments are particularly strong, but the cutting knife as a whole remains flexible. It has also been shown that this can reduce tensions between the hardened region or more hardened region, respectively, and the unhardened region or less hardened region, respectively, of the cutting knife.

The plurality of segments can also be hardened, in particular, more hardened than the remaining part of the at least one cutting knife. In other words, not only the blade edges but the segments as a whole can be hardened. This can improve the strength of the plurality of segments. Since the segments are spaced from one another by the recesses, the synergistic effect arises that the plurality of segments is particularly strong, but that the cutting knife, as a whole, remains flexible. It has also been shown that this can reduce tensions between the hardened region or more hardened region, respectively, and the unhardened region or less hardened region, respectively.

Each recess can extend into the transition region between the unhardened region or less hardened region, respectively, and the hardened region or more hardened region, respectively, of the at least one cutting knife. The recesses can also extend into the unhardened region or less hardened region, respectively, of the at least one cutting knife. This can further improve the flexibility of the cutting knife.

The blade edges of the plurality of segments can be regrindable. In other words, the segments in the region of the blade edges can have a thickness of 4-12 mm, in particular 6-10 mm, which allows the blade edges to be reground. This can extend the service life of the at least one cutting knife at low cost.

The blade edges of the plurality of segments can extend along a line or along parallel lines offset from one another. This enables more efficient manufacture of the at least one cutting knife.

Each blade edge of the plurality of segments can comprise one, in particular, two or more than two jags. In other words, the blade edges of the plurality of segments can be jagged. This allows feed to be shredded better.

The feed mixer can be a stationary mixer, a feed mixing cart, or a feed robot.

The invention also provides a cutting knife which comprises one or more of the above-mentioned features.

### BRIEF DESCRIPTION OF THE DRAWINGS

Further features and advantages of the invention shall be described hereafter with reference to the exemplary figures, where:

FIG. 1 shows an exemplary feed mixer in a schematic illustration in a perspective top view,

FIG. 2 shows a schematic sectional illustration of a further exemplary mixing container of a feed mixer in a side view,

FIG. 3 shows a perspective top view of an exemplary cutting knife in a schematic illustration,

FIG. 4 shows a top view of a further exemplary cutting knife in a schematic illustration,

FIG. 5 shows a top view of a further exemplary cutting knife in a schematic illustration,

FIG. 6 shows a top view of a further exemplary cutting knife in a schematic illustration, and

FIG. 7 shows a top view of a further exemplary cutting knife in a schematic illustration.

### DETAILED DESCRIPTION OF THE PREFERRED EMBODIMENTS

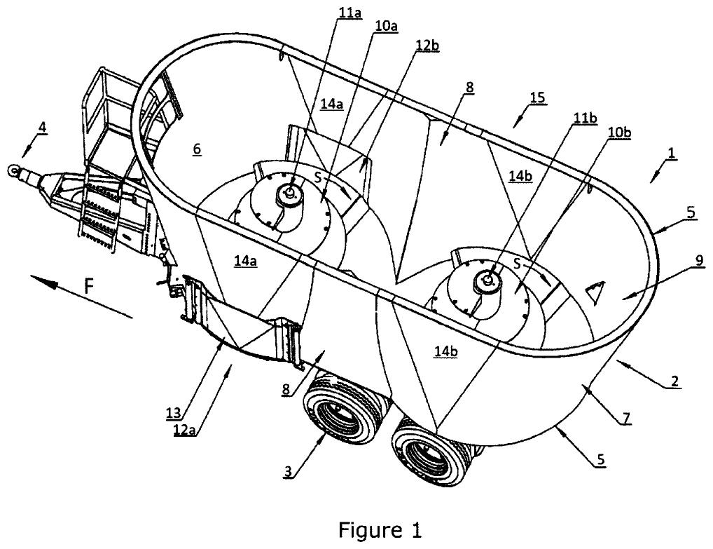

FIG. 1 shows a schematic illustration in a perspective top view of a feed mixer 1 which is configured as a feed mixing cart. Feed mixer 1 comprises a mixing container 2 that is open at the top for receiving feed and that is attached to a chassis 3 and can be moved, e.g. in a stable aisle, with the aid of a towing vehicle, such as a tractor, in direction of travel F using drawbar 4. Mixing container 2 comprises a base 5, a front wall 6, a rear wall 7 and side walls 8. Front wall 6, rear wall 7 and side walls 8 together form the walls of mixing container 2. Feed can be introduced into mixing container 2 via upper container opening 9. The feed to be mixed can be in particular long-fiber feed, such as silage or hay picked up with a loading cart.

In the interior of mixing container 2, two mixing augers 10a and 10b are arranged in direction of travel F disposed one behind the other. When feed mixer 1 is in operation, mixing augers 10a and 10b each rotate about a vertical axis 11a, 11b that runs perpendicular to base 5. In other words, mixing augers 10a and 10b are configured as vertical auger conveyors, or vertical augers for short. The direction of rotation of two mixing augers 10a, 10b is presently in the same direction and is presently clockwise in the direction of arrow S.

Next to mixing auger 10a which is the forward one in direction of travel F, there are two lateral discharge openings 12a and 12b which are arranged at the height of vertical axis 11a and disposed diametrically opposite each other on both sides of vertical axis 11a. Two discharge openings 12a and 12b penetrate side walls 8 of mixing container 2 and can each be closed by a slide 13.

When feed mixer 1 is in operation, the feed is introduced into mixing container 2 via container opening 9. Due to the two mixing augers rotating in the same direction, the feed is transported upwardly during mixing and flows back down at the upper end of the mixing auger. When metering out or discharging, feed that reaches one of two open discharge openings 12a, 12b is continuously dispensed therethrough.

Front wall 6 and rear wall 7 extend obliquely upwardly and outwardly so that container opening 9 is larger than the outline of base 5. The angle of inclination of side walls 8 is greatest in the continuation of a connecting line between axes of rotation 11a, 11b which runs parallel to direction of travel F, and decreases with increasing distance from this connecting line, up to a triangular laterally placed flattened portion 14a, 14b which is planar, touches base 5 with its tip, and extends substantially perpendicular to base 5. The width of mixing container is reduced by flattened portion 15 transverse to direction of travel F to such an extent that even narrow stable aisles can be passed.

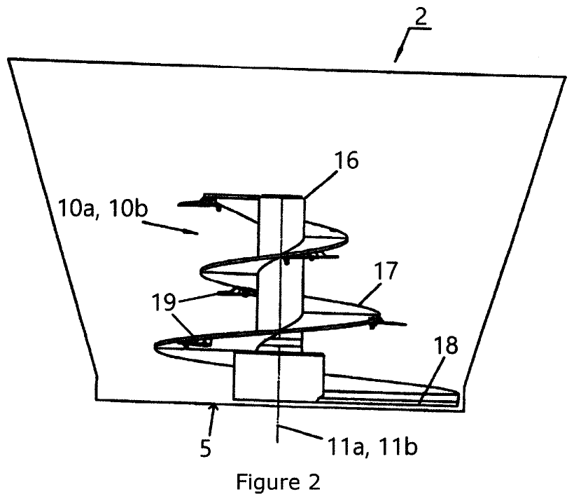

FIG. 2 shows in a schematic sectional side view a further exemplary mixing container 2 of a feed mixer 1. A mixing auger 10a, 10b is arranged in mixing container 2 and comprises a tubular auger tower 16 to which an upwardly winding auger blade 17 is attached.

Auger blade 17 begins in the lower region of mixing container 2, near its base 5, with a receiving edge 18 which continuously picks up the feed from base 5 of mixing container 2 as mixing auger 10a, 10b rotates about vertical axis 11a, 11b so that the newly picked up feed transports the already picked up mixed material further and further upwardly via auger blade 17. At the latest at the upper end of auger blade 17, the feed drops back down and forms a kind of envelopment around mixing auger 10a, 10b, which helps to hold the feed on auger blade 17.

Provided distributed about vertical axis 11a, 11b is a plurality of exemplary cutting knives 19 which are mounted at auger blade 17. Cutting knives 19 cut through in particular the feed flowing downwardly such that it is shredded.

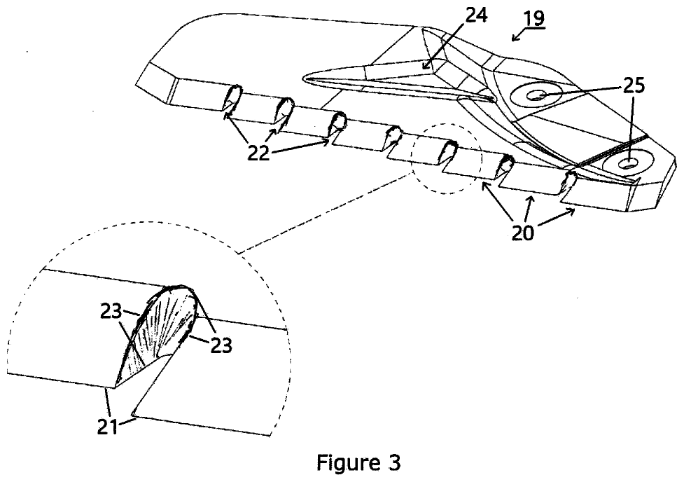

FIG. 3 shows a perspective view of an exemplary cutting knife 19 with a plurality of segments 20. The plurality of segments 20 each comprise a blade edge 21. The plurality of segments 20, in particular their blade edges 21, lie in a plane. In other words, the segments are not angled relative to each other. The plurality of segments 20 are each spaced from one another by recesses 22. Recesses 22 can have, for example, a width of 6-8 mm and a depth of 20-30 mm. In this embodiment, recesses 22 are, for example, 6 mm wide and 25 mm deep.

Recesses 22 each comprise edges 23. Edges 23 are arranged in part along the depth direction and in part along the width of recesses 22. In this example, the edges 23 are formed to be burred. However, it is also conceivable to deburr the edges so that they are sharp-edged.

Blade edges 21 of the plurality of segments 20 are offset from one another on parallel lines. During operation, blade edges 21 can point in particular in direction of rotation S of mixing auger 10a, 10b.

Exemplary cutting knife 19 furthermore comprises a reinforcement 24 and two mounting holes 25 in order to be able to mount cutting knife 19 on auger blade 17, for example, using bolts. Cutting knife 19 is deformed such that, when cutting knife 19 is mounted, the cutting plane of the plurality of segments 20 is substantially perpendicular to the axis of rotation of mixing auger 10a, 10b, i.e. is horizontal. A depression is furthermore arranged between mounting holes 25 on the side of cutting knife 19 facing auger blade 17 during assembly. With this depression, a deformation of the region in which mounting holes 25 are arranged can be compensated for, at least in part, in the course of the assembly of cutting knife 19. Without such a depression, the mounting region of cutting knife 19 can deform when it is screwed to auger blade 17. Such deformations can in turn have a negative effect on the stability and therefore on the service life of cutting knife 19.

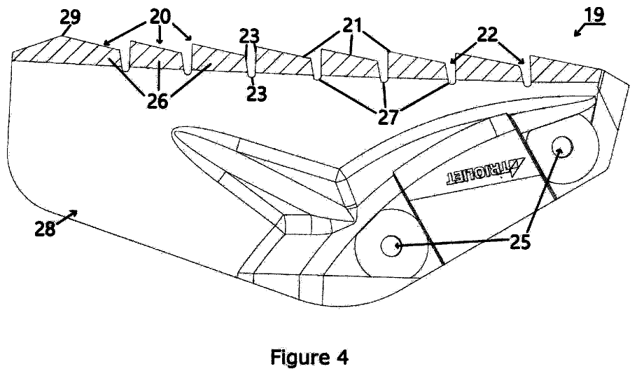

FIG. 4 shows a top view of a further exemplary cutting knife 19 with a plurality of segments 20. The plurality of segments 20 each comprise a blade edge 21. The plurality of segments 20 are spaced from one another by recesses 22. Blade edges 21 of the plurality of segments 20 are offset from one another on parallel lines.

The plurality of segments 20 is hardened. Hardened regions 26 are indicated by hatched areas. Hardened regions 26 are separated from one another by recesses 22. Each recess 22 extends in lower region 27 of respective recess 22 into unhardened region 28 of at least one cutting knife 19. Unhardened region 28 can also be a region that is less hardened than the plurality of segments 20. For example, cutting knife 19 can have a basic hardness, i.e. be hardened, and the plurality of segments 20 or regions 26 can be more hardened than the remaining part of at least one cutting knife 19.

Blade edge 21 of first segment 20 comprises a jag 29 in this example. It is also conceivable that blade edges 21 of several or all segments 20 have one or more jags 29, i.e. are formed to be jagged.

Cutting knife 19 furthermore comprises two mounting holes 25 in order to be able to mount cutting knife 19 on auger blade 17, for example, using bolts. A recess as described above can again be provided between mounting holes 25.

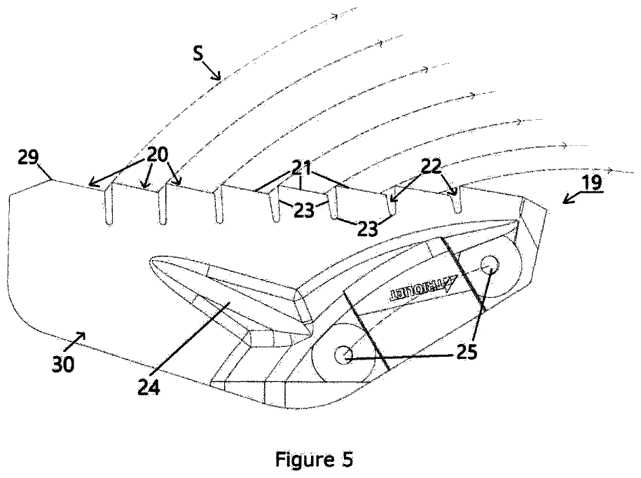

FIG. 5 shows a top view of a further exemplary cutting knife 19 with a plurality of segments 20, blade edges 21, recesses 22, edges 23, reinforcement 24, mounting holes 25 and jags 29. Recesses 22 are there formed to have different depths. The depth of recesses 22 increases with increasing distance from the axis of rotation. Recesses 22 are formed to be U-shaped. Cutting knife 19 can be mounted by way of mounting holes 25 on a mixing auger 10a, 10b that is arranged to be rotatable. Dashed arrows S indicate direction of rotation S of mixing auger 10a, 10b or circular path's about the axis of rotation of mixing auger 10a, 10b, respectively. Recesses 22 run at an angle of 50°-80° to the respective circular path. The angle there indicates the amount by which respective recess 22 has been rotated from the direction of rotation and is therefore measured starting out from circular path S. A positive angle indicates a counterclockwise rotation, a negative angle a clockwise deviation.

Cutting knife 19 comprises a knife blade 30 on which the plurality of segments 20 is formed. Knife blade 30 comprises reinforcement 24 and two mounting holes 25. Knife blade 30 can comprise a hardened or more hardened region and/or an unhardened or less hardened region, respectively. In this embodiment, knife blade 30 is unhardened.

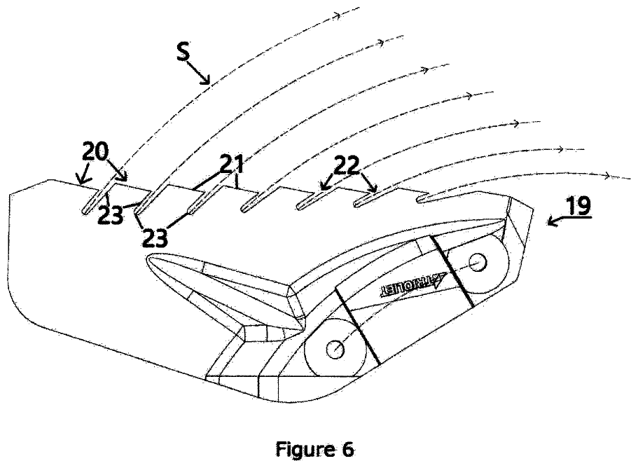

FIG. 6 shows a top view of another exemplary cutting knife 19 with a plurality of segments 20, blade edges 21, recesses 22 and edges 23. Recesses 22 are formed to have different depths. The depths of recesses 22 increase with increasing distance from the axis of rotation and extend along intersecting lines that are offset from one another, i.e. are not parallel to one another. Recesses 22 are formed to be U-shaped. Cutting knife 19 can be mounted on a mixing auger 10a, 10b formed to be rotatable. Dashed arrows S indicate direction of rotation S of mixing auger 10a, 10b or circular paths about the axis of rotation of mixing auger 10a, 10b, respectively. Recesses 22 there run at different angles to each other.

Recesses 22 are configured such that as much feed as possible gets into recesses 22 when mixing auger 10a, 10b rotates. For this purpose, recesses 22 extend substantially in the direction of rotation of mixing auger 10a, 10b or along circular paths about the axis of rotation of mixing auger 10a, 10b.

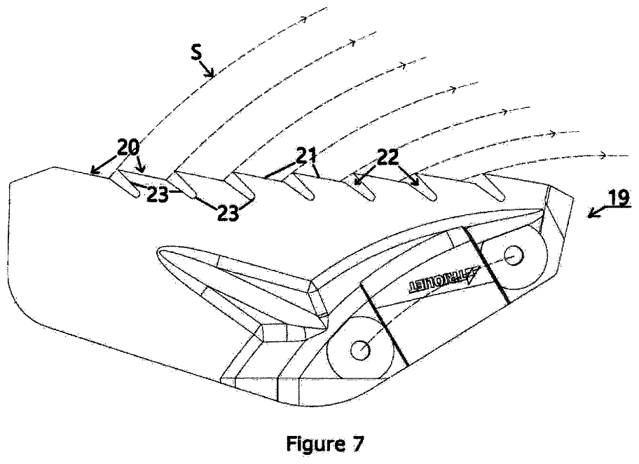

FIG. 7 shows a top view of a further exemplary cutting knife 19 with a plurality of segments 20, blade edges 21, recesses 22, and edges 23. Cutting knife 19 can be mounted on a mixing auger 10a, 10b arranged to be rotatable. Dashed arrows S indicate direction of rotation S of mixing auger 10a, 10b or circular paths about the axis of rotation of mixing auger 10a, 10b, respectively. Recesses 22 are formed to be U-shaped.

Recesses 22 are configured such that as little feed as possible gets into recesses 22 when mixing auger 10a, 10b rotates. Recesses 22 extend substantially transverse to the direction of rotation of mixing auger 10a, 10b, i.e. at an angle of approximately 90° to the respective circular path.

### LIST OF REFERENCE CHARACTERS

F direction of travel of the feed mixer
S direction of rotation of the mixing auger
1 feed mixer
2 mixing container
3 chassis
4 drawbar
5 base
6 front wall
7 rear wall
8 side walls
9 container opening
10a, 10b mixing auger
11a, 11b vertical axis
12a, 12b discharge opening
13 slide
14 laterally positioned flattened portion
15 flattened portion
16 auger tower
17 auger blade
18 pick-up edge
19 cutting knife
20 segment
21 blade edge
22 recess
23 edge
24 reinforcement
25 mounting holes
26 hardened region or more hardened region
27 lower region of the recess
28 unhardened region or less hardened region
29 serration or jag
30 knife blade

What is claimed is:

1. Feed mixer for shredding and mixing feed, in particular fibrous plant material, comprising:
a mixing container for receiving feed,
wherein said mixing container has a base and a wall extending upwardly from said base,
wherein said mixing container comprises a mixing auger arranged to be rotatable in said mixing container,
wherein said mixing auger comprises at least one cutting knife,
wherein said at least one cutting knife comprises a plurality of segments,
wherein said plurality of segments each comprises a blade edge, and
wherein said segments are spaced from one another by recesses.

2. Feed mixer according to claim 1, wherein:
each recess comprises at least one edge.

3. Feed mixer according to claim 2, wherein:
said at least one edge is arranged along the depth direction and/or along the width of said respective recess.

4. Feed mixer according to claim 2, wherein:
said at least one edge is burred, sharp-edged, or grooved.

5. Feed mixer according to claim 2, wherein:
said blade edges of said plurality of segments and/or said plurality of segments lie in a plane.

6. Feed mixer according to claim 1, wherein:
said blade edges of said plurality of segments are hardened, in particular more hardened than the remaining part of said at least one cutting knife.

7. Feed mixer according to claim 1, wherein:
said plurality of segments is hardened, in particular more hardened than the remaining part of said at least one cutting knife.

8. Feed mixer according to claim 6, wherein:
said recesses extend into an unhardened or less hardened region of said at least one cutting knife.

9. Feed mixer according to claim 1, wherein:
said blade edges of said plurality of segments extend along a line or along parallel lines offset from one another, and/or
wherein each blade edge of said plurality of segments comprises a jag, in particular two or more than two jags.

10. Feed mixer according to claim 1, wherein:
said recesses extend substantially in the direction of rotation of said mixing auger or transverse to the direction of rotation of said mixing auger.

11. Feed mixer according to claim 1, wherein:
said recesses are formed to have different depths and/or widths, and/or
wherein said recesses are arranged at different angles relative to one another and/or relative to the direction of rotation of said mixing auger.

12. Feed mixer according to claim 1, wherein:
said plurality of segments is formed to be different, in particular to have different widths, and/or
wherein said blade edges of said plurality of segments are regrindable.

13. Feed mixer according to claim 1, wherein:
said knife blade of said at least one cutting knife is deformed such that said at least one cutting knife can be mounted onto said mixing auger, in particular onto an auger blade of said mixing auger, in such a way that the cutting plane of said plurality of segments is substantially perpendicular to the axis of rotation of said mixing auger.

14. Feed mixer according to claim 1, wherein:
said knife blade of said at least one cutting knife has reinforcements, in particular pressings and/or deformations, on the upper side and/or underside.

15. Cutting knife for a feed mixer, wherein said cutting knife comprises:
a plurality of segments, wherein said plurality of segments each comprises a blade edge, and wherein said segments are spaced from one another by recesses.

16. A feed mixer for shredding and mixing feed comprising:
a mixing container;
a mixing auger placed within said mixing container, said mixing auger having a vertical axis and an upwardly winding auger blade;
a cutting knife mounted on the upwardly winding auger blade having a plurality of segments separated by a plurality of recesses formed along said cutting knife; and
each of said plurality of segments having a blade edge, the blade edge of each of said plurality of segments being offset from one another on parallel lines.
